(19) United States
(12) Patent Application Publication
(10) Pub. No.: US 2018/0185954 A1
(43) Pub. Date: Jul. 5, 2018

(54) METHOD FOR PRODUCING A MATERIAL COMPOSITE IN A ROLLING SYSTEM AND USE OF THE ROLLING SYSTEM

(71) Applicants: THYSSENKRUPP STEEL EUROPE AG, Duisburg (DE); thyssenkrupp AG, Essen (DE)

(72) Inventors: Jens-Ulrik BECKER, Duisburg (DE); Stefan MYSLOWICKI, Mönchengladbach (DE); Roland WUNDERLICH, Bergkamen (DE)

(73) Assignees: THYSSENKRUPP STEEL EUROPE AG, Duisburg (DE); thyssenkrupp AG, Essen (DE)

(21) Appl. No.: 15/737,653

(22) PCT Filed: Jun. 16, 2016
(86) PCT No.: PCT/EP2016/063947

§ 371 Date: Dec. 18, 2017

(30) Foreign Application Priority Data
Jun. 26, 2015 (DE) 10 2015 110 361.3

(51) Int. Cl. B23K 20/04; B21B 1/02; B21B 45/00; B21B 1/04; B23K 20/24

(52) U.S. Cl. CPC B23K 20/04; B21B 1/026; B21B 2001/028; B21B 1/04; B23K 20/24; B21B 45/004

(57) ABSTRACT

A process may be used to produce a composite material in a rolling plant. The process may involve providing a first workpiece and a second workpiece, which workpieces are configured in the form of a temporary composite. The process may further involve producing a planar connection between the first and second workpieces in the temporary composite by prerolling. Still further, the process may involve rolling, in particular hot rolling, the temporary composite to form the composite material after the planar connection has been produced by prerolling. The process may also involve heating the temporary composite before and/or after the prerolling.

### CROSS REFERENCE TO RELATED APPLICATIONS

This application is a U.S. National Stage Entry of International Patent Application Serial Number PCT/EP2016/063947, filed Jun. 16, 2016, which claims priority to German Patent Application No. DE 10 2015 110 361.3, filed Jun. 26, 2015, the entire contents of both of which are incorporated herein by reference.

### FIELD

The present disclosure generally relates to rolling plants and processes for producing composite materials in rolling plants.

### BACKGROUND

Processes in which slabs of different materials are assembled to form a slab packet, for example in the form of a TriBond® slab, and combined with one another by hot rolling to give a composite material in order to be able to set or realize properties of the composite material in a targeted manner are adequately known from the prior art. For the hot rolling, it is necessary for the slab packet to be heated to a temperature of more than 1200° C. It is desirable here for the temporary composite present in the form of the slab packet to have a homogeneous temperature distribution. Otherwise, there is a risk that bonding defects which reduce the quality of the finished composite material will occur during hot rolling. Uniform heating of the temporary composite is made difficult by partings between the workpieces, i.e. the slabs and the strips, arranged on top of one another in the temporary composite, since the heat transport in the region of such a parting is limited by the comparatively restricted heat transfer by radiation and convection. To therefore ensure the desired homogeneous temperature distribution, it is advised that the residence time in a reheating furnace, by means of which the temporary composite is heated for rolling, be increased, as a result of which the total time outlay for production of the composite material is ultimately increased.

Thus a need exists for a process for producing a composite material, by means of which a homogeneous temperature distribution can be set in a temporary composite without significantly increasing the residence time in a reheating furnace.

### BRIEF DESCRIPTION OF THE FIGURES

FIG. 1 is a sectional schematic view of an example temporary composite produced by a process according to the present disclosure.

FIG. 2 is a flow diagram of an example process for producing a composite material.

FIG. 3a is a schematic view of a section of an example rolling plant.

FIG. 3b is a schematic view of a section of an example rolling plant.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

A process for producing a composite material in a rolling plant may involve providing a first workpiece and a second workpiece in the form of a temporary composite, and rolling the temporary composite to form the composite material. A planar connection may be produced between the first workpiece and the second workpiece in the temporary composite by prerolling and intermediate heating timewise before rolling.

Compared to the prior art, the process of the invention has the advantage that a heat-transmitting join is formed by the first planar connection between the first workpiece and the second workpiece arranged in the temporary composite. This heat-transmitting join ensures improved heating-through of the temporary composite by heat transport mechanisms which are relied on for further conduction of the heat along a parting or a minimal air gap (radiation and convection). As a result of this targeted improvement in the heat input by means of the prerolling, a homogeneous temperature distribution can be established during heating of the temporary composite for rolling, without the residence time being increased.

The temporary composite is preferably a slab packet, in particular a TriBond® slab packet, in which a first workpiece is arranged between two second workpieces. Apart from such a three-layer temporary composite, it is also possible to conceive of a five-layer system in which a third workpiece is in each case arranged between the first workpiece and the second workpiece. It will be clear to a person skilled in the art that the first workpiece, the second workpiece and the third workpiece preferably differ from one another for example in terms of their material composition, i.e. the material of which they are made, or their thickness. To allow reliable transport of the temporary composite, welding seams which run along the extent of the temporary composite continuously between the first workpiece and the second workpiece are provided. Furthermore, the total thickness of the temporary composite is reduced by the prerolling by about 20%, for example from 285 mm down to 230 mm, in particular without going outside the dimensional spectrum of the slab packet. The temporary composite is prerolled in from two to three rolling passes, i.e. in from two to three passages through the rollers, in order to achieve the desired planar connection. Furthermore, it will be clear to a person skilled in the art that the planar connection between the first workpiece and the second workpiece does not have to extend over the entire possible contact region.

Advantageous embodiments and further developments of the invention can be derived from the dependent claims and also the description with reference to the drawings.

In a further embodiment of the present invention, the rolling is hot rolling.

In a further embodiment of the present invention, the temporary composite is heated, preferably to a temperature of more than 1200° C., timewise before and/or after prerolling. In this way, the temperature required for formation of the planar connection or the composite material is achieved in an advantageous manner during prerolling or hot rolling.

In a further embodiment of the present invention, the temporary composite is cooled, preferably to not more than 500° C., timewise after prerolling. As a result of the cooling, the probability of the planar connection between the first workpiece and the second workpiece being torn apart after prerolling is advantageously reduced. In particular, the temporary composite with the planar connection is subjected to intermediate storage on a push-off bed timewise after prerolling.

In a further embodiment of the present invention, a flow obstacle, for example in the form of a further slab, is conveyed or moved spatially before the temporary composite in the reheating furnace during heating. In this way, the welding seams between the first workpiece and the second workpiece, which would otherwise be endangered by the combustion gases arising in a furnace provided for heating the temporary composite, can be protected in an advantageous manner. In particular, the temporary composite is moved in the wind shadow of the further slab, preferably during prerolling. Furthermore, it is conceivable for the further slab in the wind shadow of which the temporary composite is moved to be thicker than the temporary composite, in particular at a point in time before prerolling.

In a further embodiment of the present invention, the first workpiece for forming the temporary composite is arranged between a plurality of second workpieces and/or prerolling is carried out when a proportion of the first workpiece in the temporary composite goes below a limit value. As a result, the formation of planar connections is advantageously dispensed with in cases in which, for example as a result of the comparatively small thickness of the first workpiece, the homogeneous temperature distribution in the temporary composite is achieved after the residence time desired for the production sequence, for example 180 minutes, and the formation of the planar connection is therefore unnecessary. In particular, the limit value is fixed as a function of a thickness of the individual workpieces, the material composition thereof and a number of layers of the workpieces arranged in a plurality of layers. It has been found, surprisingly and unexpectedly for a person skilled in the art, that in the case of a proportion of the first workpiece in the total temporary composite the limit value is preferably in the range from 40% to 80%, preferably from 45% to 60% and particularly preferably 50%, for a three-layer slab packet as temporary composite.

In a further embodiment of the present invention, the limit value is fixed by the number of layers of workpieces arranged above one another in the temporary composite. For example, the limit value for the workpiece 1 in the case of a five-layer slab packet as temporary composite is fixed below 50%.

In a further embodiment of the present invention, the prerolling is carried out in a preliminary section, in particular in a preliminary stand, of the rolling plant and rolling is carried out both in the preliminary section and also in a manufacturing section of the rolling plant. In this way, the prerolling and the rolling can be decoupled from one another in such a way that no time delay occurs in the production of the composite material in the manufacturing section as a result of prerolling. Furthermore, the temporary composite is preferably rolled in an oscillating manner in the preliminary stand. Whether the number of rolling passes selected is even or odd depends, inter alia, on whether the temporary composite is pushed off onto the push-off bed spatially before or behind the preliminary stand after prerolling.

In a further embodiment of the present invention, the temporary composite is provided in a preheated state, preferably at from 300° C. to 500° C., by means of a preheating furnace and is arranged in a reheating furnace, preferably in a walking beam furnace, a rotary hearth furnace or a tunnel furnace, for heating, preferably to at least 1220° C. The use of a pusher furnace is avoided in order to prevent the planar connection from being parted by the mechanical forces acting on the temporary composite in the pusher furnace.

In a further embodiment of the present invention, the composite material is reeled up timewise after rolling.

The present invention further provides for the use of a rolling plant for carrying out a process according to the invention, wherein a preheating furnace for preheating, a reheating furnace for heating, a preliminary stand for prerolling and a manufacturing section for rolling are provided in the rolling plant, with the preliminary stand being utilized for forming a planar connection between the first workpiece and the second workpiece. In particular, the process is integrated into a manufacturing line, i.e. into an existing production stream.

Compared to the prior art, the present invention has the advantage that a planar connection can be realized in the temporary composite by means of the use according to the invention of the rolling plant. This join increases the thermal conductivity and thus allows a homogeneous, i.e. uniform, temperature distribution to be able to be established in the temporary composite within the desired residence time.

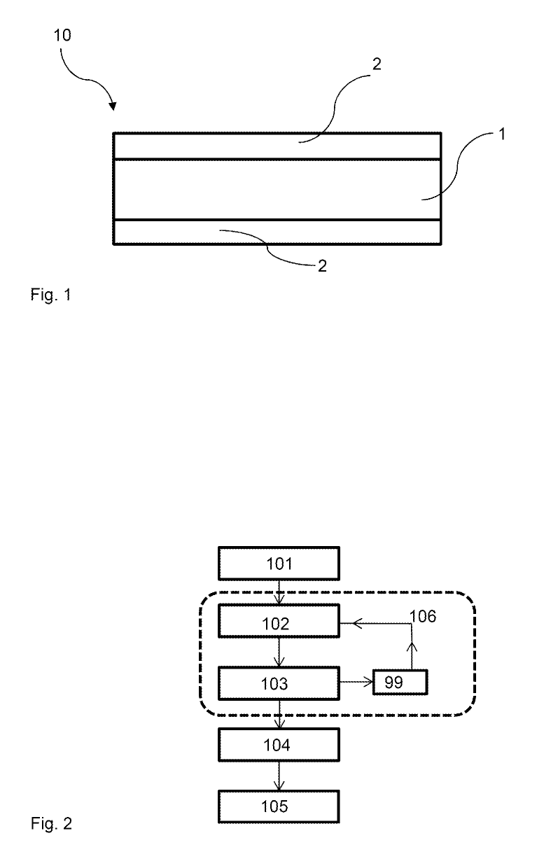

FIG. 1 depicts a temporary composite 10 made up of a first workpiece 1 and two second workpieces 2 for a process according to one illustrative embodiment of the present invention. In particular, the temporary composite 10 is a slab packet in which the first workpiece 1 is enclosed in a sandwich-like manner by two second workpieces 2 and thus forms a multilayer, in particular a three- or five-layer, system composed of various workpieces. For transport of the temporary composite 10, a welding seam, in particular, which runs along the extent of the temporary composite 10 and joins the first workpiece 1 and the second workpiece 2 to one another and holds them together is provided. The multilayer temporary composite 10 is preferably provided in order to produce a composite material, in particular in the form of a strip, therefrom by means of a rolling procedure 104, in particular by means of a hot rolling process. For successful hot rolling, a homogeneous temperature distribution over the entire temporary composite 10 is advantageous. To heat the temporary composite 10, the latter is arranged in a reheating furnace 4. During a fixed residence time of, for example, more than 180 minutes, the temporary composite 10 should attain the desired temperature, for example at least 1200° C., in the reheating furnace 4. However, partings and intermediate spaces which are present between the first workpiece 1 and the second workpiece 2 after assembly of the temporary composite 10 prevent the first workpiece 1 and the second workpiece 2 from lying against one another durably and a heat-conducting contact being formed thereby. As a result, heat input into the temporary composite 10 in the direction of its core region, i.e. in the direction of a region located centrally in the interior of the temporary composite 10, is reduced and attainment of the desired homogeneous temperature distribution during the residence time is thus made difficult. Although an increase in the residence time in the reheating furnace could bring even the core region of the temporary composite 10 to the desired temperature, the production time for production of the composite material would be disadvantageously increased. It is an object of the present invention to provide a process in which the desired temperature is achieved in the core region of the temporary composite 10 without the residence time in the reheating furnace 4 being significantly increased. For this purpose, the first workpiece 1 and the second workpiece 2 arranged in the temporary composite 10 are joined to one another over an area. This enables a heat-conducting contact between the first workpiece 1 and the second workpiece 2 to be realized, so as to ensure such an improvement in the thermal conductivity that the temporary composite 10 can be heated in the core region without significantly increasing the residence time. Furthermore, the realization of the planar connection is made dependent on a percentage, in particular by volume, of the first workpiece 1 as a fraction of the total temporary composite 10 and/or the number of layers of workpieces in the multilayer temporary composite. It has been found, surprisingly and unexpectedly for a person skilled in the art, that in the case of a three-layer temporary composite 10 as depicted here, in which the first workpiece 1 is enclosed by two second workpieces 2, a planar connection has a positive effect in the sense of the object of the invention on the residence time when the proportion of the first workpiece 1 makes up less than 60%, preferably less than 55% and particularly preferably less than 50%, of the total temporary composite 10. In particular, a limit value for the percentage of the first workpiece is therefore laid down, with the limit value determining whether the planar connection between the first workpiece 1 and the second workpiece 2 is to be realized by prerolling. In particular, the planar connection is realized when the percentage is below the limit value. Furthermore, the limit value is matched to the number of layers. For example, the limit value for a five-layer temporary composite 10 is increased relative to the limit value for a three-layer temporary composite 10. Utilization of such a limit value advantageously prevents a planar connection from being formed unnecessarily.

FIG. 2 depicts a flow diagram of a process for producing a composite material according to the illustrative embodiment of the present invention. Here, the temporary composite 10 is firstly preheated, for example in a preheating furnace 3, to up to 500° C. To form the planar connection between the first workpiece 1 and the second workpiece 2, prerolling 103 of the temporary composite 10 in a preliminary stand 5 is provided. During the preceding renewed heating 102 in a reheating furnace 4, e.g. in a tunnel furnace or a walking beam furnace, the heat input is improved by the planar connection so that it can be ensured, without significantly increasing the residence time, that the core region of the temporary composite is heated to the temperature intended for rolling 104, for example at least 1200° C. During the prerolling 103, it is preferably ensured that a dimensional spectrum of the temporary composite 10 is not left, while the composite material, for example in the form of a 3 mm thick metal sheet, is manufactured by the rolling and finally provided, after reeling-up 105, for further processing.

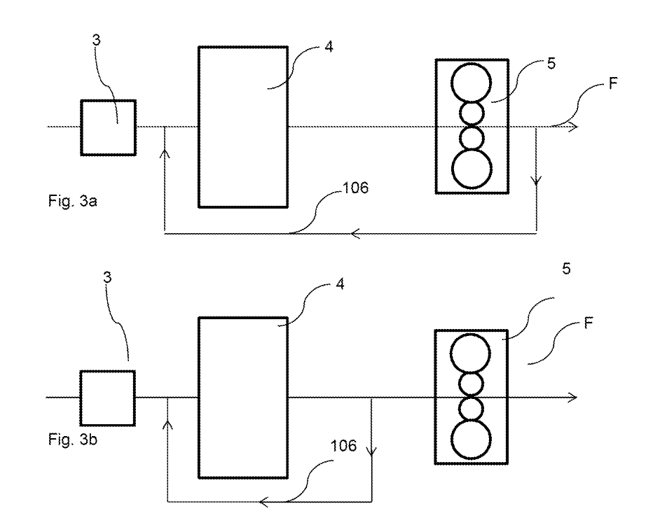

FIGS. 3a and 3b schematically show sections of a rolling plant for producing a composite material according to a first illustrative embodiment and a second illustrative embodiment of the present invention. In particular, FIGS. 3a and 3b in each case depict the preheating furnace 3, the reheating furnace 4 and the preliminary stand 5 through which the temporary composite 10 is conveyed along a transport direction before the manufacturing section. In particular, the temporary composite 10 is, after cooling of the temporary composite 10 to not more than 500° C., fed back into the reheating furnace 4 via a return facility 106. In FIG. 3a, the temporary composite 10 is returned to the reheating furnace 4 after a single rolling pass, i.e. after a single passage through the rollers, while in FIG. 3b rolling is carried out in an oscillating manner and the composite is usually returned to the reheating furnace 4 after an even number of rolling passes.

### LIST OF REFERENCE NUMERALS

1 first workpiece
2 second workpiece
3 preheating furnace
4 reheating furnace
5 preliminary stand
10 temporary composite
99 push-off bed
101 preheating
102 heating
103 prerolling
104 rolling
105 reeling-up
106 return facility

1.-11. (canceled)

12. A process for producing a composite material in a rolling plant, the process comprising:
providing a first workpiece and a second workpiece, which are configured as a temporary composite;
producing a planar connection between the first workpiece and the second workpiece in the temporary composite by prerolling; and
rolling the temporary composite to form the composite material after the planar connection is produced.

13. The process of claim 12 wherein the rolling comprises hot rolling the temporary composite.

14. The process of claim 12 further comprising heating the temporary composite at least one of before the prerolling or after the prerolling.

15. The process of claim 14 wherein the heating comprises heating the temporary composite to more than 1200° C.

16. The process of claim 14 further comprising conveying a flow obstacle spatially before the temporary composite during the heating.

17. The process of claim 12 further comprising cooling the temporary composite after the prerolling.

18. The process of claim 17 wherein the cooling comprises cooling the temporary composite to not more than 500° C.

19. The process of claim 12 wherein at least one of:
the second workpiece is one of a plurality of second workpieces, wherein the process further comprises positioning the first workpiece between the plurality of second workpieces; or
the prerolling occurs when a proportion of the first workpiece in the temporary composite exceeds a limit value.

20. The process of claim 19 wherein the limit value is fixed by a number of layers of the workpieces positioned above one another in the temporary composite.

21. The process of claim 12 wherein the prerolling occurs in a preliminary section of the rolling plant, wherein the rolling occurs in the preliminary section and a manufacturing section of the rolling plant.

22. The process of claim 12 wherein the temporary composite is provided in a preheated state by way of a preheating furnace and is positioned in a reheating furnace for heating.

23. The process of claim 22 wherein the reheating furnace is a walking beam furnace or a tunnel furnace.

24. The process of claim 22 wherein the temporary composite is heated in the reheating furnace to at least 1220° C.

25. The process of claim 12 further comprising reeling up the composite material after the rolling.

26. A rolling plant comprising:
a preheating furnace for preheating a temporary composite comprised of a first workpiece and a second workpiece;
a reheating furnace for heating;
a preliminary stand for prerolling the temporary composite to produce a planar connection between the first workpiece and the second workpiece; and
a manufacturing section for rolling the temporary composite with the planar connection to form a composite material.

27. The rolling plant of claim 26 wherein the reheating furnace is a walking beam furnace or a tunnel furnace.

28. The rolling plant of claim 26 wherein the reheating furnace is configured to produce temperatures at least as high as 1220° C.
